(19) United States
(12) Patent Application Publication
(10) Pub. No.: US 2021/0117503 A1
(43) Pub. Date: Apr. 22, 2021

(54) COMPUTER-IMPLEMENTED SYSTEMS AND METHODS FOR MANIPULATING AN ELECTRONIC DOCUMENT

(71) Applicant: COUPANG CORP., Seoul (KR)

(72) Inventors: Byoung In LIM, Seoul (KR); Jin Su Lee, Seoul (KR); Seon Ah Kim, Seoul (KR); Jun Young Mun, Seoul (KR); Suk Min Ahn, Seoul (KR)

(21) Appl. No.: 16/656,631

(22) Filed: Oct. 18, 2019

(51) Int. Cl. G06F 17/21; G06F 16/93; G06F 16/22; G06F 16/25; G06F 3/0481

(52) U.S. Cl. CPC G06F 17/211; G06F 16/93; G06F 3/0481; G06F 16/258; G06F 16/2228

(57) ABSTRACT

Disclosed embodiments provide systems and methods for defining, inserting, and digitizing attachment data. A method defining, inserting, and digitizing attachment data comprises receiving, from a user device, a request for inserting an attachment to a first document, preparing an interface for defining an attribute, receiving the defined attribute, and preparing a data structure comprising a definable input corresponding to the received defined attribute. The method further comprises transmitting the prepared data structure to a user device, receiving an updated data structure from the user device, and digitizing the defined input based on a data format associated with the attribute. The method further comprises generating an attachment including the digitized input and an electronic document by inserting the generated attachment to the first document.

### TECHNICAL FIELD

The present disclosure generally relates to computerized systems and methods for manipulating an electronic document. In particular, embodiments of the present disclosure relate to inventive and unconventional computer-implemented systems, methods, and user interfaces for efficiently manipulating metadata incorporated in attachment of an electronic document by defining, inserting, and digitizing the metadata.

### BACKGROUND

Paper negotiable instruments and documents (contracts) often require an attachment specifying information associated with the contracts. For example, attachments to a sales contract may include metadata describing a list of products and corresponding prices associated with the sales contract. As electronic documents become more universally accepted and demanded, there exist a need to create a process to insert metadata in such attachments.

Historically, electronic systems that allow for inserting a metadata in the attachment of contract typically require developing a tool for each new contract. For example, if a party wants to add an attachment including a list of products to an instant sales offer contract, a new tool with the capability of inserting metadata for a product identifier and name is required. Moreover, a new server is also required to store and reuse the input data. The new server would digitize the metadata and implement a method for storing the digitized metadata for each contract. This is cumbersome as it requires custom-built systems for each new contract.

Therefore, there is a need for improved methods and systems for manipulating an electronic by defining, inserting, and digitizing metadata incorporated in an attachment of electronic document.

### SUMMARY

One aspect of the present disclosure is directed to a computer-implemented system for defining, inserting, and digitizing attachment data. The computer implemented system may include one or more memory devices storing instructions. The computer-implemented system may also include one or more processors configured to execute the instructions to perform operations. The operations may comprise receiving, from a user device, a request for inserting an attachment to a first document, the attachment comprises at least one definable attribute, preparing an interface comprising one or more inputs for defining the attribute, the attribute comprises an attribute name and a data format, and responding to the received request by presenting the interface within a web browser in the user device. The operations may further comprise receiving the definable attribute from the interface, preparing a data structure comprising a definable input corresponding to the received definable attribute, and responding to the received attribute by transmitting the data structure to the user device. The operations may further comprise receiving the data structure from the user device, digitizing the defined input based on the data format associated with the attribute, and generating an attachment including the digitized input and an electronic document by inserting the generated attachment to the first document.

Another aspect of the present disclosure is directed to a method for defining, inserting, and digitizing attachment data. The method may comprise receiving, from a user device, a request for inserting an attachment to a first document, the attachment comprises at least one definable attribute, preparing an interface comprising one or more inputs for defining the attribute, the attribute comprises an attribute name and a data format, and responding to the received request by presenting the interface within a web browser in the user device. The method may further comprise receiving the definable attribute from the interface, preparing a data structure comprising a definable input corresponding to the received definable attribute, and responding to the received attribute by transmitting the data structure to the user device. The method may further comprise receiving the data structure from the user device, digitizing the defined input based on the data format associated with the attribute, and generating an attachment including the digitized input and an electronic document by inserting the generated attachment to the first document.

Yet another aspect of the present disclosure is directed to a computer-implemented system for defining, inserting, and digitizing attachment data. The computer implemented system may include a database and one or more memory devices storing instructions. The computer-implemented system may also include one or more processors configured to execute the instructions to perform operations. The operations may comprise receiving, from a first user device, a request for inserting an attachment to a first document, the attachment comprises at least one definable attribute, preparing an interface comprising one or more inputs for defining the attribute, the attribute comprises an attribute name and a data format, responding to the received request by presenting the interface within a web browser in the user device. The operations may further comprise receiving the defined attribute from the interface, preparing a data structure comprising a definable input corresponding to the received attribute, and responding to the received attribute by transmitting the data structure to the first user device. The operations may further comprise receiving the data structure from the first user device, digitizing the defined input based on the data format associated with the attribute, and generating an attachment including the digitized input and an electronic document by inserting the generated attachment to the first document. The operations may further comprise receiving, from a second user device, a request for accessing the stored attachment, retrieving the stored attachment from the database, and transmitting the retrieved attachment to the second user device.

Other systems, methods, and computer-readable media are also discussed herein.

### BRIEF DESCRIPTION OF THE DRAWINGS

FIG. 1 depicts a block diagram of an exemplary computer system, consistent with the disclosed embodiments.

FIG. 2 depicts a logical diagram of an exemplary system for defining, inserting, and digitizing attachment data, consistent with the disclosed embodiments.

FIG. 3A is an exemplary flowchart of process for defining, inserting, and digitizing attachment data, consistent with the disclosed embodiments

FIG. 3B is a continuing exemplary flow chart of process for defining, inserting, and digitizing attachment data, consistent with the disclosed embodiments.

FIG. 4 is an exemplary user interface of a mobile device displayed on a web browser for defining an attachment comprising one or more attributes, consistent with the disclosed embodiments.

FIG. 5 depicts an exemplary definable attribute received from the exemplary user interface in FIG. 4.

FIG. 6 depicts an exemplary data structure comprising a definable input corresponding to each of definable attributes prepared by a server in FIG. 2.

FIG. 7 depicts an exemplary attachment comprising attributes incorporating digitized inputs.

### DETAILED DESCRIPTION

The following detailed description refers to the accompanying drawings. Wherever possible, the same reference numbers are used in the drawings and the following description to refer to the same or similar parts. While several illustrative embodiments are described herein, modifications, adaptations and other implementations are possible. For example, substitutions, additions, or modifications may be made to the components and steps illustrated in the drawings, and the illustrative methods described herein may be modified by substituting, reordering, removing, or adding steps to the disclosed methods. Accordingly, the following detailed description is not limited to the disclosed embodiments and examples. Instead, the proper scope of the invention is defined by the appended claims.

Embodiments of the present disclosure are directed to systems and methods configured for monitoring logistics. The disclosed embodiments provide innovative technical features that allow defining, inserting and digitizing metadata incorporated in an attachment of electronic document. For example, the disclosed embodiments enable preparation of an interface for defining an attribute of attachment and transmission of the interface to a user device, receiving the definable attribute from the user device, preparation of a data structure comprising a definable input corresponding to the received definable attribute and transmission of the data structure to the user device, receiving an updated data structure from the user device, digitizing the defined input incorporated in the updated data structure, and storing the digitized input in a database. The updated data structure, in the form of tables, data structures, etc., may be attached to a first document. Any digitized input incorporated in the data structure may provide information associated with the first document. For example, if a first document is related to a sales contract in the form of a Microsoft Word document, an attachment may include a list of products and information associated with each of the products (digitized input) in the form of a Microsoft Excel spreadsheet, and the disclosed embodiments may insert the spreadsheet into the first document.

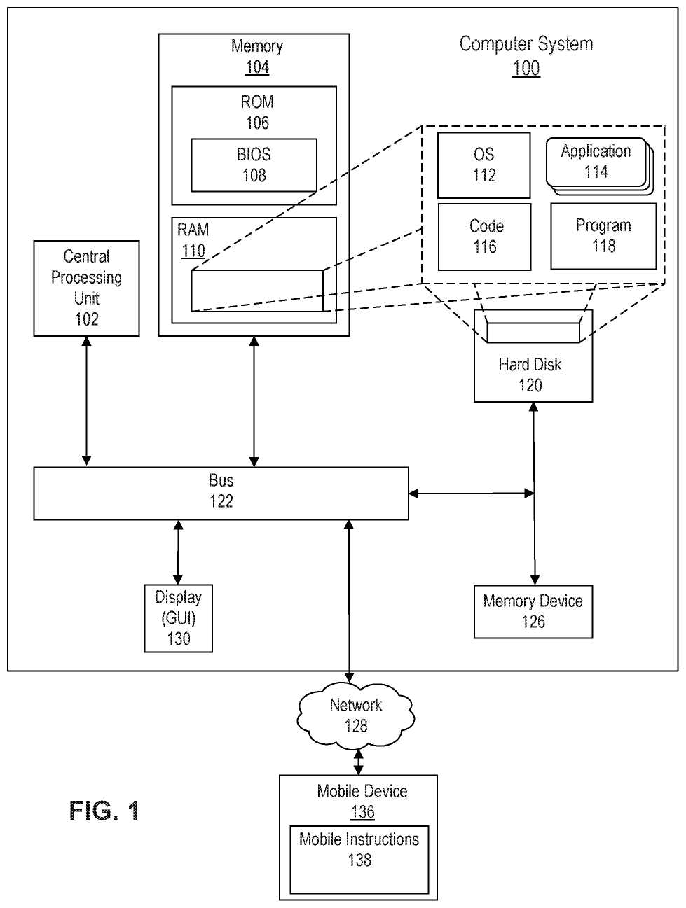

FIG. 1 depicts a block diagram of an exemplary computer system 100, consistent with disclosed embodiments. Components of system 100 may include a central processing unit (CPU) or processor 102, a memory unit 104, and a bus 122 that interconnects system components including memory 104 and CPU 102. Computer system 100 can include computer-readable media, such as volatile or nonvolatile computer storage media implemented in a method or technology suitable for storing computer-readable instructions, data structures, program modules, of the like (e.g., RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other suitable medium).

Bus 122 can be a suitable type of bus structure, such as a memory bus or memory controller, a peripheral bus, and a local bus using a suitable bus architecture. By way of example, and not limitation, such architectures can include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus—also known as Mezzanine bus.

Memory 104 can include computer-readable media, such as read only memory (ROM) 106 and random access memory (RAM) 110. A basic input/output system (BIOS) 108, containing the basic routines that help to transfer information between elements within computer system 100 is typically stored in ROM 106. Additionally, RAM 110 may contain operating system (OS) 112, applications 114, other code 116 that may be executed by one or more different programs, and program 118. RAM 110 typically contains data and/or program modules that are immediately accessible to and/or presently being operated on by CPU 102.

Hard disk drive 120 can be removable/non-removable and volatile/nonvolatile computer media. The hard disk drive 120 can read from or write to non-removable, nonvolatile magnetic media, and a memory device 126. Other removable/non-removable and volatile/nonvolatile computer storage media that can be used in exemplary computer system 100 include, but are not limited to, magnetic tape cassettes, flash memory cards, digital versatile disks, digital video tape, solid state RAM, and solid state ROM. The disks and their associated computer media, discussed above and illustrated in FIG. 1, provide storage of computer-readable instructions, programmable code, data structures, program modules and other data for computer system 100. In FIG. 1, hard disk 120 is illustrated as storing an operating system (OS) 112, one or more applications 114, other programmable code 116, and a program 118.

Memory device 126 can be an optical disk drive or a magnetic disk drive that reads from or writes to a removable and nonvolatile storage medium such as an optical disk or magnetic disk.

A user can enter commands and information into computer system 100 through an input device such as a keyboard and mouse, trackball or touch pad tablet, electronic digitizer, or microphone. Other input devices can include a joystick, game pad, satellite dish, or scanner. These and other input devices can be connected to CPU 102 through an input interface that is coupled to bus 122, or through other interfaces or bus structures, such as a parallel port, game port or a universal serial bus (USB). A display (GUI) 130 or other type of video device can also be connected to bus 122 via an interface, such as a video interface. In addition, an output device, such as speakers or a printer, can be connected to bus 122 through an output interface.

Computer system 100 can operate in a networked environment using a network 128 and a mobile device 136. Mobile device 126 can be used by a user who wants to manipulate metadata incorporated in an attachment to an electronic document. Computer system 100 can also include a personal computer, a server, a router, a network PC, a peer device or other common network node. Mobile device 136 can include a handheld, tablet, or client device. Network 128 depicted in FIG. 1 can include a local area network (LAN), a wide area network (WAN), or other type of network. Such networking environments are commonplace in offices, enterprise-wide computer networks, intranets, and the Internet. In a networked environment, programmable code and application programs can be stored in remote computers. By way of example, FIG. 1 illustrates mobile instructions 138 as residing on mobile device 136. It will be appreciated that the network connections shown are exemplary and other means of establishing communication between computers and mobile device 136 can be used.

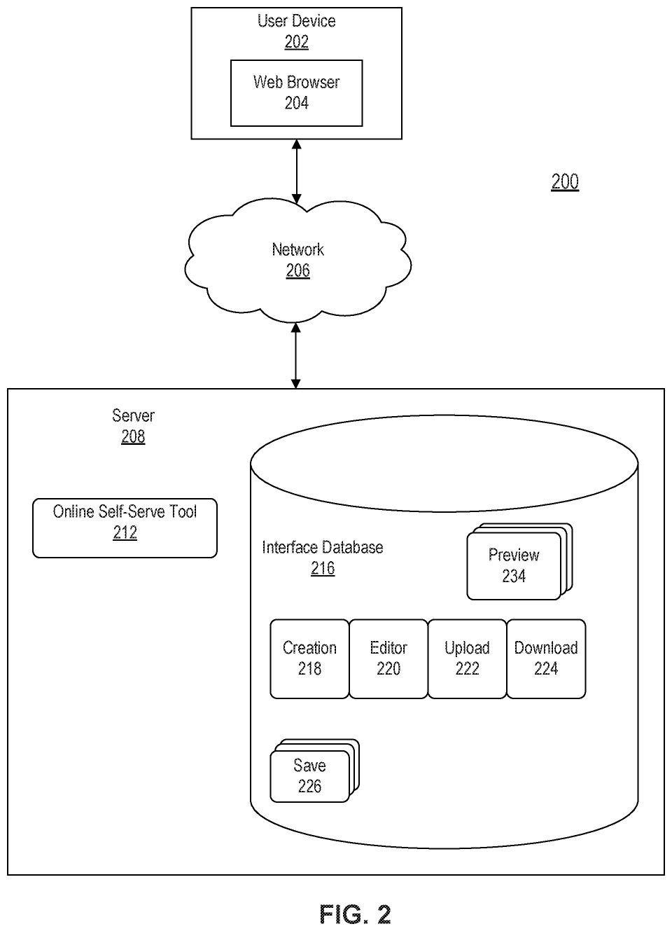

FIG. 2 depicts a logical diagram of an exemplary system for manipulating metadata incorporated attached to an electronic document, consistent with disclosed embodiments. In various embodiments, a user device 202 can be mobile device 136 or any other computing device, such as computer system 100 of FIG. 1. User device 202 can be operably coupled to one or more servers 208 by a network 206.

Network 206 can be a suitable network, such as a local area network (LAN), a wide area network (WAN), or other type of network. A web browser 204 can execute on computer 100 (as shown) or mobile device 136 (not shown), and web browser 204 can include functionality for receiving data entered at user device 202 as part of a self-serve tool consisting of a plurality of graphical user interfaces (GUIs). In general, web browser 204 can be implemented using interpreted or executable software code such as a kernel component, an application program, a script, a linked library, an object with methods, and so forth. The particular implementation of web browser 204 is not intended to be limiting. Web browser 204 can be configured to display interfaces, such as the interfaces described herein, for interacting with the disclosed system for manipulating metadata incorporated in an attachment of electronic document. As would be appreciated by those of skill in the art, additional interfaces may also be used to interact with the disclosed system.

Server 208 can be a suitable computer system or computing device, such as computer system 100 of FIG. 1. In some instances, server 208 can be part of a cloud computing platform (e.g., Microsoft Azure, or the like). In various instances, server 208 can be configured to host at least one of online self-serve tool 212 or interface database 216.

Interface database 216 can include a creation interface 218, an editor interface 220, an upload interface 222, and a download interface 224. Creation interface 218 may enable user device 202 to create a file or document in interface database 216 and editor interface 220 may enable user to edit a file or document stored in interface database 216. Upload interface 222 may enable user device 202 to upload a file or document in interface database 216 and download interface 224 may enable user device 202 to download a file or document stored in interface database 216.

Interface database 216 can also include multiple save interfaces 226 and multiple preview interfaces 234. Save interfaces 226 may enable user device 202 to save a file or document in interface database 216 and preview interfaces 234 may enable user device 202 to preview a file or document stored in interface database 216. Other interfaces (not shown) can be contemplated for display to user device 202 and for interacting with online self-serve tool 212. Each of the interfaces and associated modules for displaying the interfaces can include suitable executable software code such as a kernel component, an application program, a linked library, an object with methods, or other type of executable software code. User device 202 can utilize one or more of the interfaces to manipulate metadata.

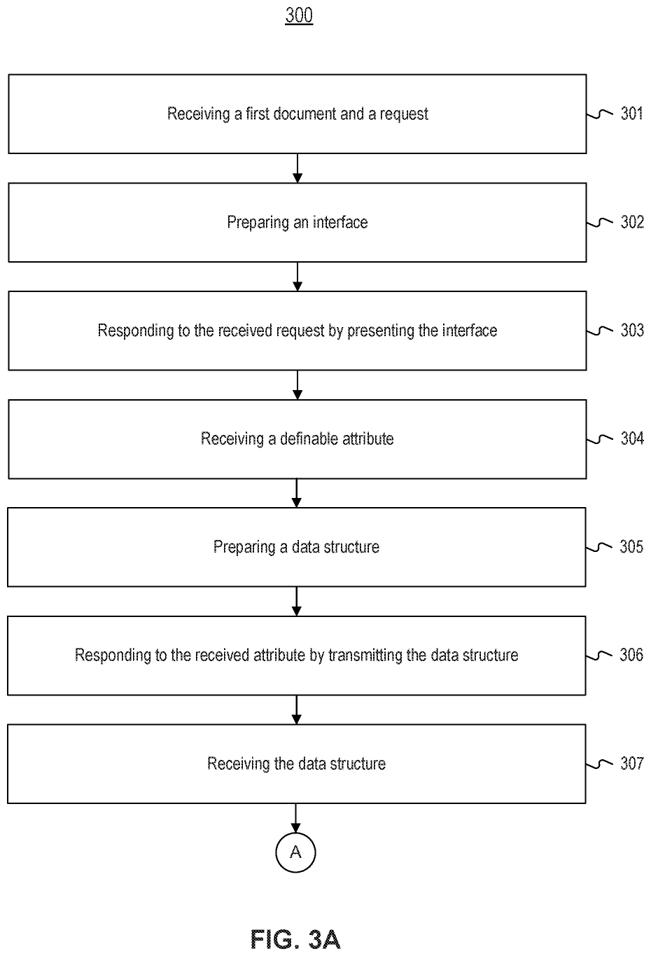

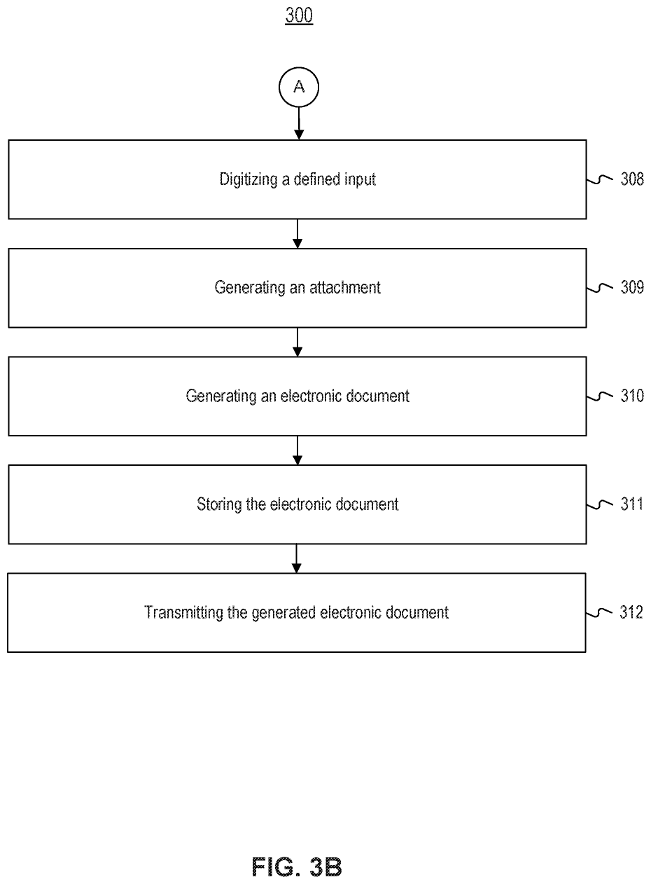

FIG. 3A is an exemplary flow chart of process 300 for manipulating metadata incorporated in an attachment to an electronic document, consistent with the disclosed embodiments. This exemplary method is provided by way of example. Method 300 shown in FIG. 3A can be executed or otherwise performed by server 208. Method 300 as described below may be carried out by server 208 by way of example. Each block shown in FIG. 3A represents one or more processes, methods, or subroutines in the exemplary method 300. Referring to FIG. 3A, exemplary method 300 may begin at block 301.

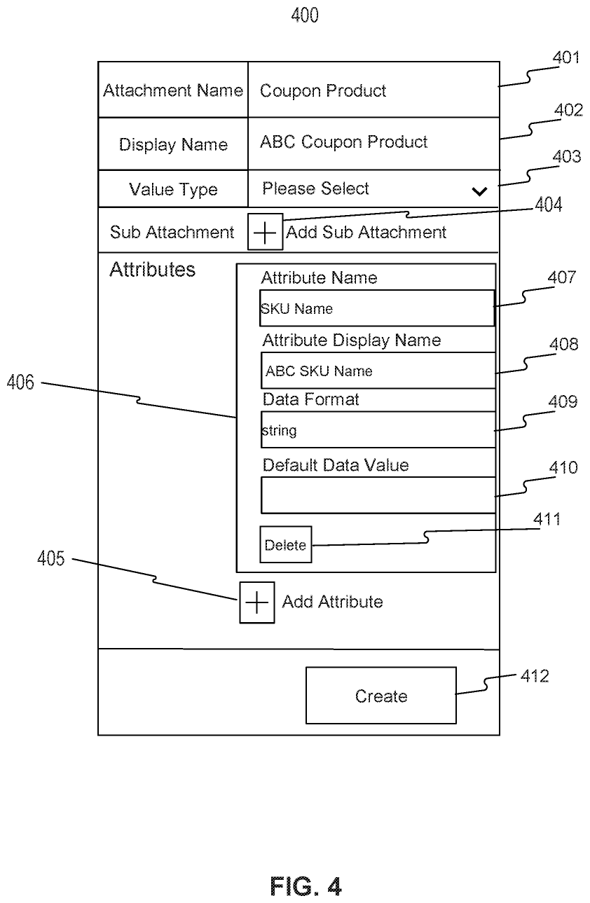

In step 301, server 208 may receive a request for inserting an attachment into a first document (e.g., an electronic document) from a user device 202. While user device 202 is referenced in explaining the method of FIG. 3A, it should be noted that devices with similar capacities and components of computer system 100 may carry out the method of FIG. 3A, as appropriate. The attachment may comprise at least one definable attribute (metadata). The definable attribute, described below in further detail with respect to FIG. 4, may describe information incorporated in the attachment. User device 202 may use a web browser 204 displayed on the user device 202 to transmit the request for inserting an attachment to a first document. For example, web browser 204 may provide a user interface for requesting an insertion of attachment, and user device 202 may configure a control implemented in the user interface to request the insertion. The control may be in the form of a button that user device 202 can press or click the button to request the insertion.

A user associated with user device 202 may also use a web browser 204 displayed on the user device 202 to select a first document in which to insert an attachment. In some embodiments, web browser 204 may enable user device 202 to select a first document from documents stored in database (not pictured) implemented in the user device 202. In another embodiment, web browser 204 may enable user device 202 to select a first document from documents stored in interface database 216 as interface database 216 is discussed above with respect to FIG. 2 for including save interfaces 226 to save a file or document in interface database 216.

In step 302, server 208 may prepare an interface comprising one or more inputs for defining the attribute. The attribute may include Stock Keeping Unit (SKU) ID, SKU name, vendor item ID, or vendor item name. The interface may include one or more elements for defining an attachment and an attribute. The element associated with an attribute may include at least one of an attribute name or a data format. The data format may include string, integer, floating-point, and character. The one or more inputs correspond to the elements and are provided with empty input fields that can be defined when a user associated with user device 202 enters data in the empty input fields. The exemplary interface comprising inputs for defining the attachment and the attribute is illustrated in FIG. 4 and will be discussed in more detail.

In step 303, server 208 may respond to the received request from step 301 by presenting the user interface prepared in step 302 within a web browser 204 in user device 202. A user associated with user device 202 may use a web browser 204 displayed on the user device 202 to define an attribute by entering data on an input field corresponding to an element included in the attribute in the user interface. After defining the attribute by entering data on the user interface, user device 202 may transmit the definable attribute to the server 208. For example, a user associated with user device 202 may configure a control implemented in the user interface to transmit a defined attribute to server 208. The control may be in the form of a button or a selectable element that user can press or click to transmit the defined attribute.

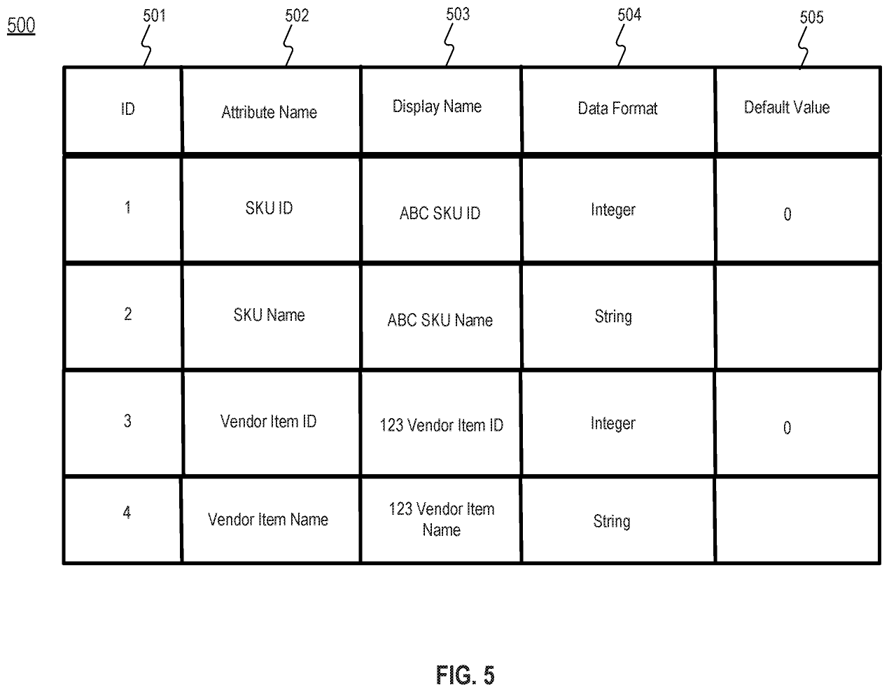

In step 304, server 208 may receive the definable attribute from the interface presented in step 303 transmitted from the user device 202. An exemplary definable attribute is depicted in FIG. 5 and will be discussed in more detail. When the definable attribute is received, server 208 may implement an indicator to the received definable attribute. The indicator may suggest that the received definable attribute is linked or connected to the first document selected in step 301.

In some embodiments, server 208 may enable user device 202 to edit the first document using the web browser 204. Server 208 may provide editor interface 220 to user device 202 and user device 202 may edit the first document in which the attachment is intended to be inserted.

In some embodiments, server 208 may enable user device 202 to request to insert data corresponding to the received definable attribute by using a control implemented in the editor interface 220. For example, a user associated with user device 202 may configure a control implemented in editor interface 220, which is displayed on web browser 204, to request for inserting data after editing a document. The control may be in the form of button or selectable element that the user can press or click to request the insertion. In another embodiment, server 208 may enable user device 202 to insert data without any requests. For example, when server 208 receives a definable attribute in step 304, it may automatically regard the received definable attribute as a request for inserting data and prepare a data structure in step 305.

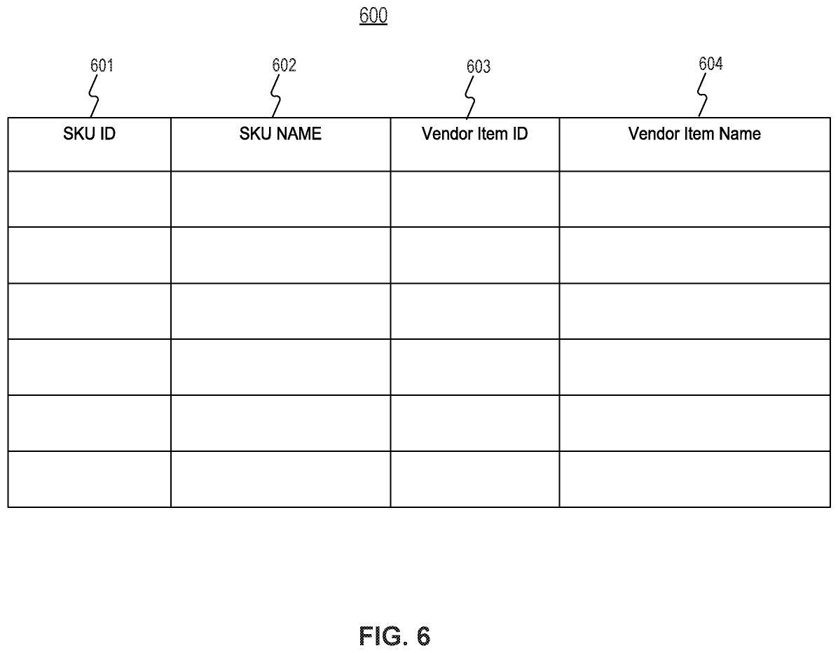

In step 305, server 208 may prepare a data structure comprising a definable input corresponding to the received definable attribute. The data structure may include a spreadsheet, a table, a worksheet, a grid, a list, a chart, an array, a hash, a linked list, a text file, or any suitable format enabling user device 202 to enter data to define one or more attributes. The exemplary data structure comprising definable attributes is illustrated in FIG. 6 and is discussed in more detail below.

In step 306, server 208 may respond to the received attribute by transmitting the prepared data structure to user device 202. In some embodiments, server 208 may enable user device 202 to define an input corresponding to the definable attribute by entering data to the input by using web browser 204. For example, server 208 may enable user device 202 to define an input by providing editor interface 220 to user device 202. In another embodiment, server 208 may enable user device 202 to define an input by enabling user device 202 to download the data structure, define an input by entering data in the data structure, and upload or transmit the updated data structure to server 208. For example, server 208 may provide download interface 224 for user device 202 to download a data structure and upload interface 222 to upload an updated data structure. FIG. 6 depicts an exemplary data structure 600 comprising four attributes 601-604. User device 202 may enter data as suggested by the top row comprising attributes 601-604 via web browser 204 in user device 202. In the exemplary data structure 600, user device 202 is provided with six inputs for each attribute 601-604. Other numbers of inputs can be provided to server 208 and other numbers of attributes can be defined by user device 202 by adding or reducing a number of definable attributes using the prepared interface in step 303.

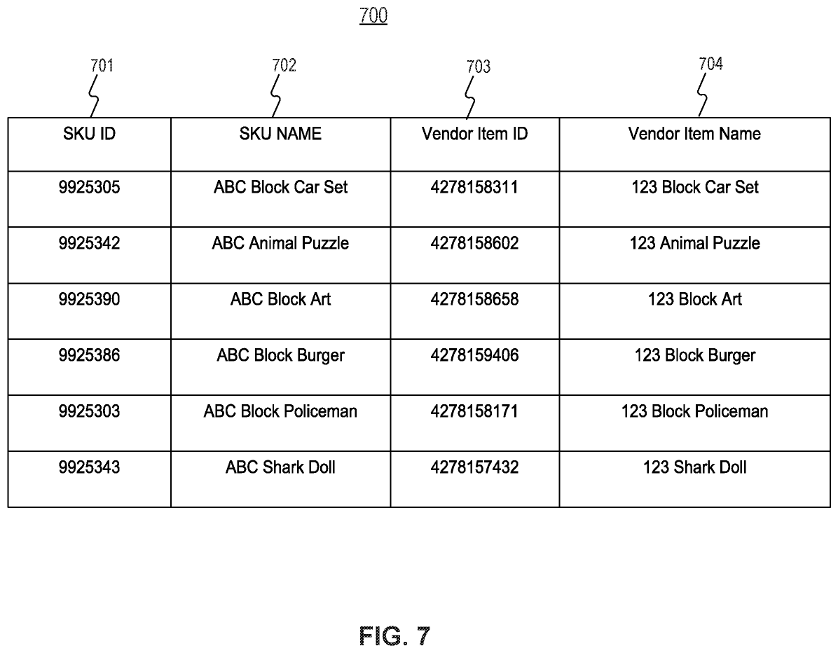

In step 307, server 208 may receive the data structure from user device 202. When server 208 receives the data structure, server 208, in step 308, may digitize the defined input incorporated in the data structure based on the data format associated with the definable attribute. Server 208 may digitize the defined input by converting the defined input into a digital form that can be processed by a computer. For example, if server 208 received an attribute with “SKU ID” attribute name and integer data format (as depicted in the first row of FIG. 5) in step 304, and further received a defined input “9925305” in a data structure in step 307 (as depicted in the second row of attachment 700 in FIG. 7), server 208 may covert “9925305” into an integer. In another example, if server 208 received an attribute with “SKU Name” attribute name and string data format (as depicted in the second row of FIG. 5) in step 304, and further received a defined input “ABC Block Car Set” in a data structure in step 307 (as depicted in the second row of attachment 700 in FIG. 7), server 208 may covert “ABC Block Car Set” into string.

Server 208 may also determine whether the defined input matches the data format before digitizing the defined input. If server 208 determines that the defined input does not match the data format, in some embodiments, server 208 may not digitize the defined input. For example, if a word “ABCDE” is defined as input for an attribute associated with integer data format, server 208 may not convert “ABCDE” into a digital form because “ABCDE” cannot be converted into an integer. In another embodiment, server 208 may digitize a default data value associated with a corresponding attribute when the defined input does not match the data format.

In some embodiments, if the received data structure comprises an undefined input, server 208 may digitize default data value. For example, if a default data value is 100 and a data format is integer for an undefined input, server 208 may convert 100 into integer.

In step 309, server 208 may generate an attachment including the digitized input from step 308. For example, an exemplary attachment 700 (in the form of table) is generated by server 208, wherein all inputs corresponding to attributes 701-704 are digitized based on data formats associated with the attributes.

In step 310, server 208 may construct an electronic document by inserting the generated attachment from step 309 into the first document. For example, server 208 may insert the generated attachment by inserting a link associated with the attachment at the end of the first document that, when actuated, may enable user device 202 to view the attachment. In another example, server 208 may insert the generated attachment by appending the generated attachment at the end of the first document. By way of further example, server 208 may insert the generated attachment by embedding the generated attachment to the first document.

In step 311, server 208 may store the generated electronic document from step 310 in interface database 216. In some embodiments, server 208 may automatically store the generated electronic document in interface database 216. In another embodiment, server 208 may enable user device 202 to save the generated electronic document by providing save interface 226 to user device 202. As all data incorporated in the attachment are digitized, user device 202 or another user device can access server 208 may easily retrieve the attachment and the data. The attachment can be inserted to another document. In step 312, server 208 may transmit the generated electronic document to user device 202.

FIG. 4 depicts an exemplary user interface 400 of a user device 202 displayed on web browser 204 for defining an attachment comprising one or more attributes, consistent with the disclosed embodiment. Interface 400 may include inputs 401 and 402, an indicator 403, buttons 404 and 405. The exemplary user interface 400 is depicted to define “Coupon Product” attachment including an attribute (metadata) SKU name, but one of ordinary skill in the art would understand that user interface may be implemented to define other types of attachment and attributes.

A user may enter data in inputs 401 and 402 to define an attachment. For example, as shown in FIG. 4, a user may enter attachment name “Coupon Product” in input 401 and display name “ABC Coupon Product” in input 402. Indicator 403 may provide a value type of attachment. The value type, in some embodiments, may be either “single” or “multi,” and may be updated based on a presence of sub-attachment. For example, indicator 403 may indicate that a value type of attachment is multi when a sub-attachment exists and further indicate that a value type of attachment is single when a sub-attachment does not exist. Server 208 may consider the value type to retrieve and use a definable attribute. For example, for a single value type attachment, server 208 may use an attribute defined by interface 400 for a current attachment. In another example, for a multi value type attachment, server 208 may retrieve and use an attribute comprised in a sub-attachment.

User interface 400 may receive a press on button 404 to add a sub-attachment. When user interface 400 receives a press, user interface 400 may provide one or more inputs for defining the sub-attachment. The addition of sub-attachment may assist in combining two different attachments into one. In some embodiments, the two attachments are stored in interface database 216. For example, various types of attachments may exist per contract, such as an attachment comprising an item ID and an item name as attributes (Attachment A) and another attachment comprising a coupon discount rate and an event as attributes (Attachment B). A combination of Attachment A and Attachment B may be needed to generate an attachment (Attachment C) comprising attributes from both Attachment A and Attachment B. In such cases, Attachment C may comprise Attachment A and Attachment B as sub-attachments. Definable attributes from each of the Attachment A and the Attachment B may be reused to define attributes of Attachment C. Rather than redefining a similar or frequently used attribute, an attribute from other stored attachments can be reused. Attachment C comprises two sub-attachments, thus indicator 403 is updated to multi and server 208 may retrieve and use definable attributes associated with the two sub-attachments (e.g., Attachment A and Attachment B).

User interface 400 may receive a press on button 405 to add a definable attribute 406. The definable attribute 406, when defined by the user interface 400, may provide information associated with a first document. For example, if a first document is related to a sales contract for one or more products, an attachment to the sales contract may provide a list of products and definable attribute may describe an attribute of each of the products such as SKU name, SKU ID, vendor item name, vendor item ID, etc. When user interface 400 receives a press, user interface may generate inputs 407-410 and a button 411 to define attribute 406. For example, as shown in FIG. 4, user may enter attribute name “SKU Name”, attribute display name “ABC SKU Name”, data format “string”, and default value to define attribute 407. Button 411, when pressed, may delete attribute 406. User interface 400 may receive a press on button 412 to transmit definable attribute 407 to server 208 as discussed above with respect to FIG. 3A.

FIG. 5 depicts an exemplary definable attribute 500 received from user interface 400 in FIG. 4, consistent with the disclosed embodiment. Receiving a definable attribute is discussed above with respect to step 304 in FIG. 3A. The definable attribute 500 may comprise an identifier 501, an attribute name 502, a display name 503, a data format 504, and a default value 505. Server 208 may assign identifier 501 to a definable attribute. For example, if server 208 receives four definable attributes, it may assign four different identifiers to each of the four definable attributes. Once server 208 assigns identifier 501, server 208 may link or connect attribute name 502, display 503, data format 504, and default value 505 to the identifier 501 for each attribute. Server 208 may link or connect the definable attribute 500 to a first document.

FIG. 6 depicts an exemplary data structure 600 comprising a definable input (e.g., an empty box) corresponding to each of definable attributes 601-604 prepared by server 208 in step 305 in FIG. 3A, consistent with the disclosed embodiment. As discussed above, a user may use web browser 204 or download data structure 600 to enter data into an empty box to define an input corresponding to a definable attribute.

FIG. 7 depicts an exemplary attachment 700 comprising attributes 701-704 incorporating digitized inputs. Each attribute 701-704 includes one or more inputs digitized in step 308 in FIG. 3B. As discussed above, attachment 700 may be stored in interface database 216 as part of step 311 (FIG. 3B) and can be retrieved or accessed by user device 202 or other users. The exemplary attachment 700 provides a list of products included in “Coupon Product” attachment (defined in FIG. 4), wherein each of the products is described by SKU ID, SKU name, vendor item id, and vendor item name.

While the present disclosure has been shown and described with reference to particular embodiments thereof, it will be understood that the present disclosure can be practiced, without modification, in other environments. The foregoing description has been presented for purposes of illustration. It is not exhaustive and is not limited to the precise forms or embodiments disclosed. Modifications and adaptations will be apparent to those skilled in the art from consideration of the specification and practice of the disclosed embodiments. Additionally, although aspects of the disclosed embodiments are described as being stored in memory, one skilled in the art will appreciate that these aspects can also be stored on other types of computer readable media, such as secondary storage devices, for example, hard disks or CD ROM, or other forms of RAM or ROM, USB media, DVD, Blu-ray, or other optical drive media.

Computer programs based on the written description and disclosed methods are within the skill of an experienced developer. Various programs or program modules can be created using any of the techniques known to one skilled in the art or can be designed in connection with existing software. For example, program sections or program modules can be designed in or by means of .Net Framework, .Net Compact Framework (and related languages, such as Visual Basic, C, etc.), Java, C++, Objective-C, HTML, HTML/AJAX combinations, XML, or HTML with included Java applets.

Moreover, while illustrative embodiments have been described herein, the scope of any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application. The examples are to be construed as non-exclusive. Furthermore, the steps of the disclosed methods may be modified in any manner, including by reordering steps and/or inserting or deleting steps. It is intended, therefore, that the specification and examples be considered as illustrative only, with a true scope and spirit being indicated by the following claims and their full scope of equivalents.

1. A computer-implemented system for digitizing attachment data, comprising:
one or more memory devices storing instructions; and
one or more processors configured to execute the instructions to perform operations comprising:
receiving, from a user device, a request for inserting an attachment to a text document, the attachment comprises at least one definable attribute;
preparing an interface comprising one or more inputs for defining the attribute, the attribute comprises an attribute name and a data format;
responding to the received request by presenting the interface within a web browser in the user device;
receiving the definable attribute from the interface;
preparing a data structure comprising a definable input corresponding to the received definable attribute;
responding to the received attribute by transmitting the data structure to the user device;
receiving the data structure from the user device;
digitizing the defined input by converting the defined input into a predefined data type,_based on the data format associated with the attribute;
generating a table including the digitized input;
generating a link to the table; and
generating an electronic document by appending the link at the end of the text document.

2. The computer-implemented system of claim 1, wherein the attribute further comprises at least one of display name or default data value.

3. The computer-implemented system of claim 2, wherein the default data value is digitized as the defined input when the received data structure does not define the attribute.

4. The computer-implemented system of claim 1, wherein the attribute is at least one of product name, Stock Keeping Unit ID, Stock Keeping Unit name, vendor item ID, or vendor item name.

5. The computer-implemented system of claim 1, wherein the operations further comprise storing the generated electronic document and transmitting the generated electronic document to the user device.

6. The computer-implemented system of claim 1, wherein the prepared interface comprises a selectable element for adding new attributes and a selectable element for deleting the attribute.

7. The computer-implemented system of claim 1, wherein the data structure is an array, a hash, a linked list, a text file, or a table.

8. The computer-implemented system of claim 1, wherein the operations further comprise determining whether the defined input matches the data format before digitizing the defined input.

9. The computer-implemented system of claim 1, wherein the user device is a computer or mobile device.

10. The computer-implemented system of claim 1, wherein the data format comprises string, integer, floating-point, and character.

11. A method for digitizing attachment data, comprising:
receiving, from a user device, a request for inserting an attachment to a text document, the attachment comprises at least one definable attribute;
preparing an interface comprising one or more inputs for defining the attribute, the attribute comprises an attribute name and a data format;
responding to the received request by presenting the interface within a web browser in the user device;
receiving the definable attribute from the interface;
preparing a data structure comprising a definable input corresponding to the received definable attribute;
responding to the received attribute by transmitting the data structure to the user device;
receiving the data structure from the user device;
digitizing the defined input by converting the defined input into a predefined data type, based on the data format associated with the attribute;
generating a table including the digitized input;
generating a link to the table; and
generating an electronic document by appending the link at the end of the text document.

12. The method of claim 11, wherein the attribute further comprises at least one of display name or default data value.

13. The method of claim 12, wherein the default data value is digitized as the defined input when the received data structure does not define the attribute.

14. The method of claim 11, wherein the operations further comprise storing the generated electronic document and transmitting the generated electronic document to the user device.

15. The method of claim 11, wherein the prepared interface comprises a selectable element for adding new attributes and a selectable element for deleting the attribute.

16. The method of claim 11, wherein the data structure is array, hash, linked list, structured text file, or table.

17. The method of claim 11, wherein the operations further comprise determining whether the defined input matches the data format before digitizing the defined input.

18. The method of claim 11, wherein the user device is a computer or mobile device.

19. The method of claim 11, wherein the data format comprises string, integer, floating-point, and character.

20. A computer-implemented system for digitizing attachment data, comprising:
a database;
one or more memory devices storing instructions; and
one or more processors configured to execute the instructions to perform operations comprising:
receiving, from a user device, a request for inserting an attachment to a first text document, the attachment comprises at least one definable attribute;
preparing an interface comprising one or more inputs for defining the attribute, the attribute comprises an attribute name and a data format;
responding to the received request by presenting the interface within a web browser in the user device;
receiving the definable attribute from the interface;
preparing a data structure comprising a definable input corresponding to the received definable attribute;
responding to the received attribute by transmitting the data structure to the user device;
receiving the data structure from the user device;
digitizing the defined input by converting the defined input into a predefined data type, based on the data format associated with the attribute;
generating an attachment in a table format including the digitized input;
generating a link to the attachment; and
generating an electronic document by the appending the link at the end of the text document;
storing the attachment in the database;
receiving, from a second user device, a request for accessing the stored attachment;
retrieving the stored attachment from the database; and
transmitting the retrieved attachment to the second user device.
